(19) United States
(12) Patent Application Publication
(10) Pub. No.: US 2023/0241823 A1
(43) Pub. Date: Aug. 3, 2023

(54) PLASTICIZING DEVICE, THREE-DIMENSIONAL SHAPING DEVICE, AND INJECTION MOLDING DEVICE

(71) Applicant: SEIKO EPSON CORPORATION, Tokyo (JP)

(72) Inventors: Taki HASHIMOTO, Shiojiri (JP); Kazuhide NAKAMURA, Higashichikuma-gun (JP)

(21) Appl. No.: 18/161,112

(22) Filed: Jan. 30, 2023

(30) Foreign Application Priority Data
Feb. 1, 2022 (JP) 2022-014224

(51) Int. Cl. B29C 45/60; B29C 45/47; B29C 64/295; B29C 64/20; B33Y 30/00

(52) U.S. Cl. CPC B29C 45/60; B29C 45/47; B29C 64/295; B29C 64/20; B33Y 30/00

(57) ABSTRACT

A plasticizing device includes: a flat screw having a groove forming surface and a length in a rotation axis direction shorter than a length in a direction perpendicular to the rotation axis direction; a barrel that has a facing surface facing the groove forming surface and in which a communication hole communicating with the facing surface is formed; and a heating unit configured to heat a material supplied into a groove. In a region in which the groove forming surface and the facing surface face each other, a surface free energy of the groove forming surface is lower than a surface free energy of the facing surface.

The present application is based on, and claims priority from JP Application Serial Number 2022-014224, filed Feb. 1, 2022, the disclosure of which is hereby incorporated by reference herein in its entirety.

### BACKGROUND

### 1. Technical Field

The present disclosure relates to a plasticizing device, a three-dimensional shaping device, and an injection molding device.

### 2. Related Art

Various plasticizing devices that plasticize a material are used in the related art. For example, JP-A-2010-241016 discloses a plasticizing and feeding device including a rotor in which a spiral groove is formed, and a barrel in which one end surface comes into contact with an end surface of the rotor and a material inflow passage is opened at the center.

In a plasticizing device including a rotor having a groove forming surface in which a groove is formed at one end in a rotation axis direction, and a barrel in which a communication hole is formed in a facing surface facing the groove forming surface, such as the plasticizing and feeding device in JP-A-2010-241016, the material may not be stably plasticized. This is because a material that is being plasticized and a plasticized material in a region in which the groove forming surface and the facing surface face each other adhere to a rotor side and are less likely to be supplied to the communication hole on a barrel side.

### SUMMARY

According to an aspect of the present disclosure for solving the above problems, a plasticizing device for a material is provided. The plasticizing device includes: a flat screw that is rotatable about a rotation axis, that has a groove forming surface in which a groove is formed, and that has a length in a direction along the rotation axis shorter than a length in a direction perpendicular to the direction along the rotation axis; a barrel that has a facing surface facing the groove forming surface and in which a communication hole communicating with the facing surface is formed; and a heating unit configured to heat the material supplied into the groove. The groove forming surface has a region having a surface free energy lower than a surface free energy of the facing surface.

### BRIEF DESCRIPTION OF THE DRAWINGS

FIG. 1 is a schematic diagram of a three-dimensional shaping device including a plasticizing device according to an embodiment of the present disclosure.

FIG. 2 is a perspective view showing a schematic configuration of a lower surface side of a flat screw of the three-dimensional shaping device in FIG. 1.

FIG. 3 is a schematic plan view showing an upper surface side of a barrel of the three-dimensional shaping device in FIG. 1.

FIG. 4 is a schematic diagram of an injection molding device including a plasticizing device according to an embodiment of the present disclosure.

### DESCRIPTION OF EXEMPLARY EMBODIMENTS

First, the present disclosure will be schematically described.

According to a first aspect of the present disclosure for solving the above problems, a plasticizing device for a material is provided. The plasticizing device includes: a flat screw that is rotatable about a rotation axis, that has a groove forming surface in which a groove is formed, and that has a length in a direction along the rotation axis shorter than a length in a direction perpendicular to the direction along the rotation axis; a barrel that has a facing surface facing the groove forming surface and in which a communication hole communicating with the facing surface is formed; and a heating unit configured to heat the material supplied into the groove. The groove forming surface has a region having a surface free energy lower than a surface free energy of the facing surface.

According to this aspect, in a region in which the groove forming surface and the facing surface face each other, there is a region in which the surface free energy of the groove forming surface is lower than the surface free energy of the facing surface. With such a configuration, in the region, the material that is being plasticized and the plasticized material are less likely to adhere to the flat screw than to the barrel, and the material is likely to move toward the communication hole. Therefore, the material can be prevented from being less likely to be supplied to the communication hole on a barrel side, and the material can be stably plasticized.

The plasticizing device according to a second aspect of the present disclosure is directed to the first aspect, in which the groove forming surface has a first forming surface and a second forming surface that is located closer to a central side than is the first forming surface, the facing surface includes a first facing surface that faces the first forming surface and a second facing surface that faces the second forming surface and that is located closer to the central side than is the first facing surface, and a surface free energy of the first forming surface is lower than a surface free energy of the first facing surface, and a surface free energy of the second forming surface is lower than a surface free energy of the second facing surface.

According to this aspect, the surface free energy of the first forming surface is lower than the surface free energy of the first facing surface, and the surface free energy of the second forming surface is lower than the surface free energy of the second facing surface. With such a configuration, in an entire region in which the groove forming surface and the facing surface face each other, that is, in both of an outer region in which the first forming surface and the first facing surface face each other and a central region in which the second forming surface and the second facing surface face each other, the material is less likely to adhere to the flat screw than to the barrel. Therefore, it is possible to improve a conveying force with which the material moves toward the communication hole in the entire region in which the groove forming surface and the facing surface face each other. Therefore, for example, a plasticized material can be injected from a small-diameter nozzle under a high pressure.

The plasticizing device according to a third aspect of the present disclosure is directed to the first aspect, in which the groove forming surface has a first forming surface and a second forming surface that is located closer to a central side than is the first forming surface, the facing surface includes a first facing surface that faces the first forming surface and a second facing surface that faces the second forming surface and that is located closer to the central side than is the first facing surface, and a surface free energy of the first forming surface is lower than a surface free energy of the first facing surface, and a surface free energy of the second forming surface is higher than a surface free energy of the second facing surface.

According to this aspect, the surface free energy of the first forming surface is lower than the surface free energy of the first facing surface, and the surface free energy of the second forming surface is higher than the surface free energy of the second facing surface. With such a configuration, in the outer region in which the first forming surface and the first facing surface face each other, the material is less likely to adhere to the flat screw than to the barrel. Therefore, it is possible to improve the conveying force with which the material moves toward the communication hole in the outer region in which the first forming surface and the first facing surface face each other. The material in the central region in which the second forming surface and the second facing surface face each other can be thoroughly plasticized. Therefore, for example, a plasticized material can be injected with a large injection amount using a large-diameter nozzle.

The plasticizing device according to a fourth aspect of the present disclosure is directed to the first aspect, in which the groove forming surface has a first forming surface and a second forming surface that is located closer to a central side than is the first forming surface, the facing surface includes a first facing surface that faces the first forming surface and a second facing surface that faces the second forming surface and that is located closer to the central side than is the first facing surface, and a surface free energy of the first forming surface is higher than a surface free energy of the first facing surface, and a surface free energy of the second forming surface is lower than a surface free energy of the second facing surface.

According to this aspect, the surface free energy of the first forming surface is higher than the surface free energy of the first facing surface, and the surface free energy of the second forming surface is lower than the surface free energy of the second facing surface. With such a configuration, in the central region in which the second forming surface and the second facing surface face each other, the material is less likely to adhere to the flat screw than to the barrel. Therefore, the material in the outer region in which the first forming surface and the first facing surface face each other can be thoroughly plasticized. It is possible to improve the conveying force with which the material moves toward the communication hole in the central region in which the second forming surface and the second facing surface face each other. Therefore, for example, a material that is difficult to be plasticized can be injected after being thoroughly plasticized in the outer region.

The plasticizing device according to a fifth aspect of the present disclosure is directed to any one of the first aspect to the fourth aspect, in which at least one of the groove forming surface and the facing surface is subjected to a coating treatment or a cutting treatment.

According to this aspect, at least one of the groove forming surface and the facing surface is subjected to the coating treatment or the cutting treatment. Therefore, for example, the groove forming surface and the facing surface can be made of the same material. The number of types of materials that can be used for manufacturing the flat screw and the barrel can be increased.

The plasticizing device according to a sixth aspect of the present disclosure is directed to the fifth aspect, in which the facing surface is subjected to at least one of diamond coating, chromium coating, and titanium coating as the coating treatment.

According to this aspect, the facing surface is subjected to at least one of the diamond coating, the chromium coating, and the titanium coating. Therefore, a facing surface having a high surface free energy can be easily formed with high durability.

The plasticizing device according to a seventh aspect of the present disclosure is directed to the fifth aspect or the sixth aspect, in which the groove forming surface is subjected to fluorine coating as the coating treatment.

According to this aspect, the groove forming surface is subjected to the fluorine coating. Therefore, a groove forming surface having a particularly low surface free energy can be easily formed.

The plasticizing device according to an eighth aspect of the present disclosure is directed to any one of the first aspect to the seventh aspect, in which the material contains at least one of metal particles and ceramic particles.

According to this aspect, the material contains at least one of the metal particles and the ceramic particles. When a material containing at least one of the metal particles and the ceramic particles is used, the material is likely to adhere to a flat screw side in particular. However, even in such a case, the material can be prevented from adhering to the flat screw side, and the material can be prevented from being less likely to be supplied to the communication hole on the barrel side.

The plasticizing device according to a ninth aspect of the present disclosure is directed to any one of the first aspect to the eighth aspect, in which a difference in surface free energies in the region in which the surface free energy of the groove forming surface is lower than the surface free energy of the facing surface is 4.6 mJ/m² or more.

According to this aspect, the difference in the surface free energies in the region in which the surface free energy of the groove forming surface is lower than the surface free energy of the facing surface is 4.6 mJ/m² or more. With such a configuration, the material can be particularly and effectively prevented from being less likely to be supplied to the communication hole on the barrel side, and the material can be stably plasticized.

According to a tenth aspect of the present disclosure, a three-dimensional shaping device is provided. The three-dimensional shaping device includes: a nozzle configured to dispense the material plasticized by the plasticizing device according to any one of the first aspect to the ninth aspect; and a table configured to support the material dispensed from the nozzle.

According to this aspect, a three-dimensional shaped object can be shaped using a material that is stably plasticized.

According to an 11-th aspect of the present disclosure, an injection molding device is provided. The injection molding device includes: a nozzle configured to dispense the material plasticized by the plasticizing device according to any one of the first aspect to the ninth aspect; and a fixing unit configured to fix a mold configured to receive the material dispensed from the nozzle.

According to this aspect, injection molding can be performed using a material that is stably plasticized.

### Three-Dimensional Shaping Device (Plasticizing Device)

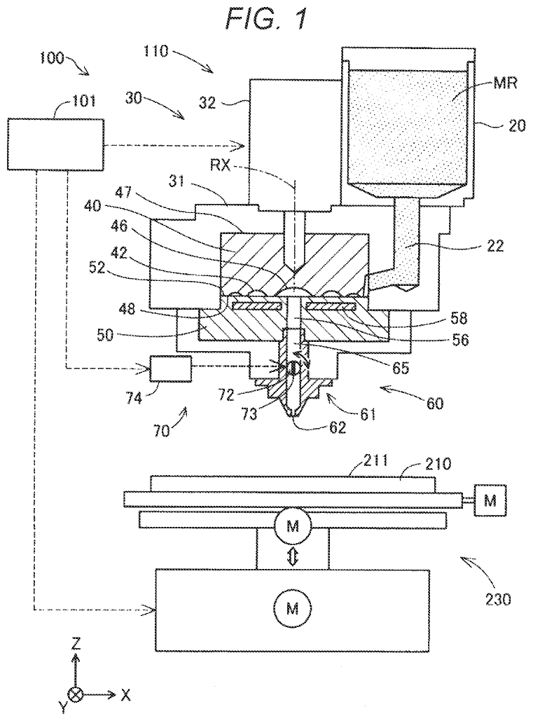

Hereinafter, embodiments of the present disclosure will be described with reference to accompanying drawings. First, an overall configuration of a three-dimensional shaping device 100 according to an embodiment of the present disclosure will be described with reference to FIGS. 1 to 3. The following drawings are all schematic diagrams, and a part of components are omitted or simplified. In the drawings, an X-axis direction is a horizontal direction, a Y-axis direction is a horizontal direction and is a direction orthogonal to the X-axis direction, and a Z-axis direction is a vertical direction.

The three-dimensional shaping device 100 includes a control unit 101 that controls the three-dimensional shaping device 100, a shaping unit 110 that generates and dispenses a shaping material, a stage 210 for shaping serving as a base of a three-dimensional shaped object, and a moving mechanism 230 that controls a dispense position of the shaping material. Under the control of the control unit 101, the shaping unit 110 dispenses a paste-shaped shaping material obtained by melting a material in a solid state onto the stage 210. The shaping unit 110 includes a material supply unit 20 that is a supply source of a raw material MR before being converted into the shaping material, a shaping material generation unit 30 that converts the raw material MR into the shaping material, and a dispensing unit 60 that dispenses the shaping material. That is, the three-dimensional shaping device 100 according to the embodiment can be regarded as a plasticizing device that plasticizes a material. The three-dimensional shaping device 100 may be regarded as a device that includes a plasticizing device including the material supply unit 20 and the shaping material generation unit 30, and dispenses a material (shaping material) plasticized by the plasticizing device from the dispensing unit 60 to shape a three-dimensional shaped object. Here, “plasticizing” is a concept including melting. In a case of a material having a glass transition point, the material is heated to a temperature equal to or higher than the glass transition point and is converted into a state having fluidity. In a case of a material not having a glass transition point, the material is heated to a temperature equal to or higher than a melting point and is converted into a state having fluidity.

The material supply unit 20 supplies the raw material MR for generating the shaping material to the shaping material generation unit 30. The material supply unit 20 is implemented with, for example, a hopper that accommodates the raw materials MR. The material supply unit 20 has a discharge port on a lower side. The discharge port is coupled to the shaping material generation unit 30 via a communication path 22. The raw material MR is put into the material supply unit 20 in a form of pellets, powder, or the like.

The shaping material generation unit 30 melts the raw material MR supplied from the material supply unit 20 to generate a paste-shaped shaping material exhibiting fluidity, and guides the shaping material to the dispensing unit 60. The shaping material generation unit 30 includes a screw case 31, a motor 32, a flat screw 40, and a barrel 50.

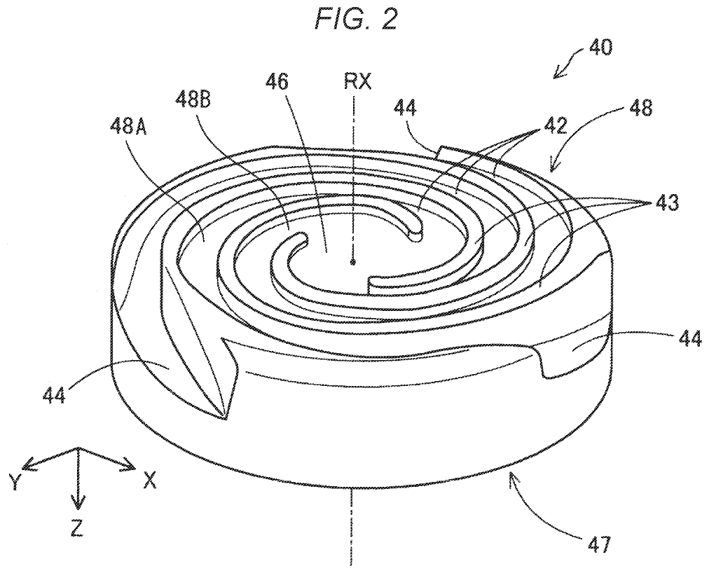

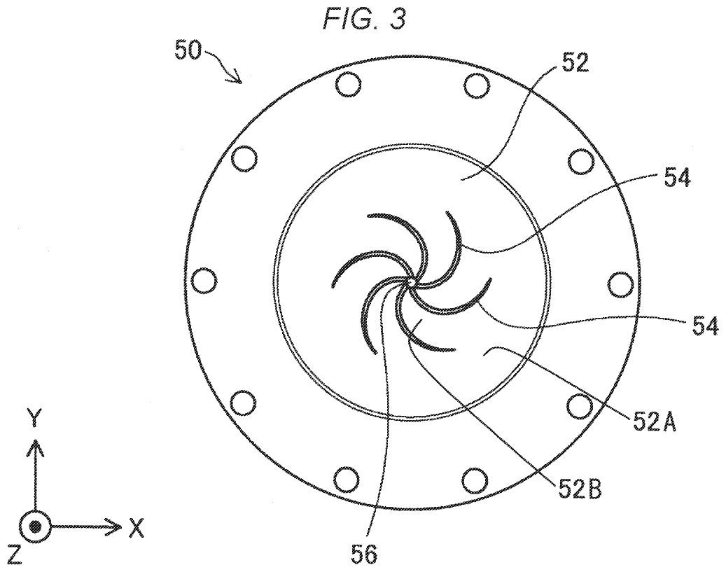

FIG. 2 is a perspective view showing a schematic configuration of a groove forming surface 48 side of the flat screw 40. In order to facilitate understanding of the technique, the flat screw 40 shown in FIG. 2 is shown in a state in which a positional relationship between an upper surface 47 and the groove forming surface 48 which is a lower surface shown in FIG. 1 is reversed in a vertical direction. FIG. 3 is a schematic plan view showing a facing surface 52 side which is an upper surface of the barrel 50. The flat screw 40 has a substantially cylindrical shape whose height in an axial direction, which is a direction along a central axis of the flat screw 40, is smaller than a diameter of the flat screw 40. In other words, the flat screw 40 is rotatable with respect to a rotation axis RX along the Z-axis direction. A length in the rotation axis direction is shorter than a length in a direction perpendicular to the rotation axis direction.

The flat screw 40 is housed in the screw case 31. An upper surface 47 side of the flat screw 40 is coupled to the motor 32. The flat screw 40 is rotated in the screw case 31 by a rotational drive force generated by the motor 32. The motor 32 is driven under the control of the control unit 101.

Grooves 42 are formed in the groove forming surface 48 of the flat screw 40 which is a surface intersecting with the rotation axis RX. The communication path 22 of the material supply unit 20 described above communicates with the grooves 42 from a side surface of the flat screw 40. As shown in FIG. 2, in the embodiment, three grooves 42 are separated from one another by convex portions 43. The number of the grooves 42 is not limited to three, and may be one or two or more.

The groove forming surface 48 of the flat screw 40 faces the facing surface 52 of the barrel 50. A space is formed between the grooves 42 of the groove forming surface 48 of the flat screw 40 and the facing surface 52 of the barrel 50. In the shaping unit 110, the raw material MR is supplied from the material supply unit 20 to material inflow ports 44 into the space between the flat screw 40 and the barrel 50.

A heater 58 serving as a heating unit that heats the raw material MR supplied into the grooves 42 of the rotating flat screw 40 is embedded in the barrel 50. However, the heating unit may be provided at a place other than the barrel 50. A plurality of guide grooves 54 coupled to the communication hole 56 and extending in a spiral shape from the communication hole 56 toward an outer periphery are formed in the facing surface 52. However, the guide groove 54 may not be formed. The raw material MR supplied into the grooves 42 of the flat screw 40 flows along the grooves 42 by the rotation of the flat screw 40 while being melted in the grooves 42, and is guided to a central portion 46 of the flat screw 40 as the shaping material. The paste-shaped shaping material that flows into the central portion 46 and that exhibits fluidity is supplied to the dispensing unit 60 via the communication hole 56 provided at the center of the barrel 50 shown in FIG. 3. In the shaping material, not all types of substances constituting the shaping material need to be melted. The shaping material may be converted into a state having fluidity as a whole by melting at least a part of types of substances among all the types of substances constituting the shaping material.

The dispensing unit 60 includes a nozzle 61 that dispenses the shaping material, a flow path 65 for the shaping material provided between the flat screw 40 and the nozzle 61, and an opening and closing mechanism 70 that opens and closes the flow path 65. The nozzle 61 is coupled to the communication hole 56 of the barrel 50 through the flow path 65. The nozzle 61 dispenses the shaping material generated by the shaping material generation unit 30 from a dispensing port 62 at a tip toward the stage 210.

The opening and closing mechanism 70 opens and closes the flow path 65 to control an outflow of the shaping material from the nozzle 61. In the embodiment, the opening and closing mechanism 70 is implemented by a butterfly valve. The opening and closing mechanism 70 includes a drive shaft 72 that is a shaft-shaped member extending in one direction, a valve body 73 that is rotated by rotation of the drive shaft 72, and a valve drive unit 74 that generates a rotational drive force of the drive shaft 72.

The drive shaft 72 is attached in a middle of the flow path 65 in a manner of intersecting a flow direction of the shaping material. More specifically, the drive shaft 72 is attached in a manner of being parallel to the Y-axis direction which is a direction perpendicular to a flow direction of the shaping material in the flow path 65. The drive shaft 72 is rotatable around a central axis along the Y-axis direction.

The valve body 73 is a plate-shaped member that is rotated in the flow path 65. In the embodiment, the valve body 73 is formed by processing a portion of the drive shaft 72 provided in the flow path 65 into a plate shape. A shape of the valve body 73 when viewed in a direction perpendicular to a plate surface thereof substantially coincides with an opening shape of the flow path 65 at a portion where the valve body 73 is disposed.

The valve drive unit 74 rotates the drive shaft 72 under the control of the control unit 101. The valve drive unit 74 includes, for example, a stepping motor. The valve body 73 is rotated in the flow path 65 by the rotation of the drive shaft 72.

A state in which a plate surface of the valve body 73 is perpendicular to the flow direction of the shaping material in the flow path 65 is a state in which the flow path 65 is closed. In this state, an inflow of the shaping material from the flow path 65 to the nozzle 61 is blocked, and an outflow of the shaping material from the dispensing port 62 is stopped. When the plate surface of the valve body 73 is rotated from a vertical state by the rotation of the drive shaft 72, the inflow of the shaping material from the flow path 65 to the nozzle 61 is allowed, and the shaping material of a dispensing amount according to a rotation angle of the valve body 73 flows out from the dispensing port 62. As shown in FIG. 1, a state along the flow direction of the shaping material in the flow path 65 is a state in which the flow path 65 is fully opened. In this state, a dispensing amount of the shaping material per unit time from the dispensing port 62 is maximized. In this way, the opening and closing mechanism 70 can implement ON and OFF of the outflow of the shaping material and adjustment of the dispensing amount of the shaping material.

The stage 210 is disposed at a position facing the dispensing port 62 of the nozzle 61. In the embodiment, a surface 211 of the stage 210 facing the dispensing port 62 of the nozzle 61 is disposed in a horizontal direction. The three-dimensional shaping device 100 shapes a three-dimensional shaped object by dispensing the shaping material from the dispensing unit 60 toward the surface 211 of the stage 210 and laminating layers.

The moving mechanism 230 changes relative positions between the stage 210 and the nozzle 61. In the embodiment, a position of the nozzle 61 is fixed. The moving mechanism 230 moves the stage 210. The moving mechanism 230 includes a three-axis positioner that moves the stage 210 in three axial directions including the X-axis direction, the Y-axis direction, and the Z-axis direction by driving forces of three motors M. The moving mechanism 230 changes a relative positional relationship between the nozzle 61 and the stage 210 under the control of the control unit 101. In the present specification, unless otherwise specified, a movement of the nozzle 61 means that the nozzle 61 is relatively moved with respect to the stage 210.

Instead of the configuration in which the stage 210 is moved by the moving mechanism 230, a configuration may be adopted in which the moving mechanism 230 moves the nozzle 61 with respect to the stage 210 in a state in which the position of the stage 210 is fixed. A configuration may be adopted in which the stage 210 is moved in the Z-axis direction by the moving mechanism 230 and the nozzle 61 is moved in the X-axis direction and the Y-axis direction, or a configuration may be adopted in which the stage 210 is moved in the X-axis direction and the Y-axis direction by the moving mechanism 230 and the nozzle 61 is moved in the Z-axis direction. With these configurations, the relative positional relationship between the nozzle 61 and the stage 210 can be changed.

The control unit 101 is a control device that controls an overall operation of the three-dimensional shaping device 100. The control unit 101 includes a computer including one or a plurality of processors, a main storage device, and an input and output interface that receives and outputs a signal from and to the outside. The control unit 101 exhibits various functions by the processor executing programs and commands read into the main storage device. Instead of being implemented by a computer, the control unit 101 may be implemented by a configuration of combining a plurality of circuits in order to implement at least a part of the functions.

As described above, the three-dimensional shaping device 100 according to the embodiment includes a flat screw that is rotatable about the rotation axis RX and that has the groove forming surface 48 in which the grooves 42 are formed at one end in the rotation axis direction, the barrel 50 that has the facing surface 52 facing the groove forming surface 48 and in which the communication hole 56 communicating with the facing surface 52 is formed, and the heater 58 that heats the material supplied into the grooves 42. Hereinafter, the flat screw 40 and the barrel 50, which are main parts of the three-dimensional shaping device 100 according to the embodiment, will be described in more detail.

The flat screw 40 and the barrel 50 of the three-dimensional shaping device 100 according to the embodiment are implemented such that, in a region in which the groove forming surface 48 and the facing surface 52 face each other, a surface free energy of the groove forming surface 48 is lower than a surface free energy of the facing surface 52. Specifically, both the flat screw 40 and the barrel 50 according to the embodiment are formed of stainless steel (SUS). The facing surface 52 is coated with titanium nitride (TiN) having a surface free energy higher than that of the SUS.

The surface free energy can be measured according to a wettability test method of a substrate glass surface of JIS R 3257 (1999). Here, Table 1 shows surface free energies obtained by measuring a contact angle between water and n-hexadecane using Drop Master 500 manufactured by Kyowa Interface Chemical Co., Ltd., and calculating the surface free energies based on a Kaelble Uy theoretical formula from a measurement result. In Table 1, polysilazane is NL120A manufactured by Merck Ltd. Japan, TaOx is ALD film formation using (t-butylimide)tris(ethylmethylamino) tantalum: TBTEMT, and SCA is OPTOOL DSX-E manufactured by Daikin Industries, Ltd. Constants of water and n-hexadecane were calculated using values shown in Table 2.

TABLE 1

| | | | Surface free energy based | | |
|---|---|---|---|---|---|
| | | | on Kaelble Uy theoretical | | |
| | Contact angle (deg) | | formula (mJ/m²) | | |
| | | n- | | p polar | |
| | | hexa- | d dispersion | compo- | |
| Evaluation target | Water | decane | component | nent | Total |
| SUS303 (plate | 105.1 | 30.1 | 24.0 | 0.3 | 24.3 |
| material: no | | | | | |
| surface | | | | | |
| treatment) | | | | | |
| SUS303 (plate | 87.3 | 6.4 | 27.4 | 3.7 | 31.1 |
| material: | | | | | |
| blasting | | | | | |
| treatment) | | | | | |
| CrN (flat screw) | 73.9 | 5.4 | 27.5 | 9.5 | 37.0 |
| CrN (plate | 85.0 | 5.2 | 27.5 | 4.5 | 32.0 |
| material) | | | | | |
| TiN (plate | 94.6 | 8.9 | 27.3 | 1.6 | 28.9 |
| material) | | | | | |
| EV coat: TiAIN | 96.7 | 14.5 | 26.7 | 1.3 | 28.0 |
| (plate material) | | | | | |
| Diamond-coated | 79.2 | 5.4 | 27.5 | 6.9 | 34.4 |
| DLC (plate | | | | | |
| material) | | | | | |
| Polysilazane + | 114.9 | 67.4 | 13.2 | 0.3 | 13.5 |
| SCA (plate | | | | | |
| material) | | | | | |
| TaOx + SCA | 113.3 | 68.3 | 12.9 | 0.5 | 13.4 |
| (plate material) | | | | | |
| ABS resin (plate | 91.0 | 24.8 | 25.1 | 3.0 | 28.1 |
| material) | | | | | |
| ABS resin plate | 89.6 | 4.8 | 27.5 | 2.9 | 30.4 |
| as shaping | | | | | |
| material | | | | | |
| SUS630 plate as | 103.8 | 12.4 | 27.0 | 0.2 | 27.2 |
| shaping material | | | | | |

TABLE 2

| | Surface free energy based on Kaelble Uy | | |
|---|---|---|---|
| | theoretical formula (mJ/m²) | | |
| Evaluation | d dispersion | p polar | |
| target | component | component | Total |
| Water | 21.8 | 51.0 | 72.8 |
| n-hexadecane | 27.6 | 0.0 | 27.6 |

As shown in Table 1, since the groove forming surface 48 is formed of the SUS, the surface free energy of the groove forming surface 48 is 24.3 mJ/m². Since the facing surface 52 is coated with TiN, the surface free energy of the facing surface 52 is 28.9 mJ/m², which is higher than that of the SUS by 4.6 mJ/m². In Table 1, SUS303 is used as the SUS. Another SUS such as SUS440 has the same value. As in the three-dimensional shaping device 100 according to the embodiment, it is preferable that, in a region in which the groove forming surface 48 and the facing surface 52 face each other, there is a region in which the surface free energy of the groove forming surface 48 is lower than the surface free energy of the facing surface 52. This is because, with such a configuration, in the region, the material that is being plasticized and the plasticized material are less likely to adhere to the flat screw 40 than to the barrel 50, and the material is more likely to move toward the communication hole 56. Further, with such a configuration, the material can be prevented from being less likely to be supplied to the communication hole 56 on a barrel 50 side, and the material can be stably plasticized.

As described above, in the three-dimensional shaping device 100 according to the embodiment, a difference between the surface free energy of the groove forming surface 48 and the surface free energy of the facing surface 52 is 4.6 mJ/m². Therefore, the difference in the surface free energies in the region in which the surface free energy of the groove forming surface 48 is lower than the surface free energy of the facing surface 52 is preferably 4.6 mJ/m² or more. This is because, with such a configuration, the material can be particularly and effectively prevented from being less likely to be supplied to the communication hole 56 on the barrel 50 side, and the material can be stably plasticized.

As described above, in the three-dimensional shaping device 100 according to the embodiment, the facing surface 52 is subjected to a coating treatment. In this way, it is preferable that at least one of the groove forming surface 48 and the facing surface 52 is subjected to the coating treatment, or at least one of the groove forming surface 48 and the facing surface 52 is subjected to a cutting treatment. This is because, with such a configuration, for example, the groove forming surface 48 and the facing surface 52 can be made of the same material, and the number of types of materials that can be used for manufacturing the flat screw 40 and the barrel 50 can be increased. Here, the “cutting treatment” also includes emboss processing, and a surface treatment with a surface treated with chemicals.

As described above, in the three-dimensional shaping device 100 according to the embodiment, the facing surface 52 is subjected to titanium coating by TiN. Preferred examples of the coating treatment on the facing surface 52 include diamond coating and chromium coating in addition to the titanium coating. The facing surface 52 is subjected to at least one of the diamond coating, the chromium coating, and the titanium coating. Accordingly, the facing surface 52 having a high surface free energy can be easily formed with high durability.

On the other hand, instead of the facing surface 52 being subjected to the coating treatment or the cutting treatment, or in addition to the facing surface 52 being subjected to the coating treatment or the cutting treatment, the groove forming surface 48 can be subjected to the coating treatment or the cutting treatment. Preferred examples of the coating treatment on the groove forming surface 48 include the fluorine coating. The groove forming surface 48 is subjected to the fluorine coating. Accordingly, the groove forming surface 48 having a particularly low surface free energy can be easily formed.

Here, as shown in FIG. 2, in the groove forming surface 48, a region that is located on an outer side when viewed from the Z-axis direction is a first forming surface 48A. A region that is located closer to the central side when viewed from the Z-axis direction than is the first forming surface 48A is a second forming surface 48B. As shown in FIG. 3, in the facing surface 52, a region that is located on the outer side when viewed from the Z-axis direction and facing the first forming surface 48A is a first facing surface 52A. A region that is located closer to the central side than is the first facing surface 52A when viewed from the Z-axis direction and that faces the second forming surface 48B is a second facing surface 52B.

In the three-dimensional shaping device 100 according to the embodiment, the first forming surface 48A and the second forming surface 48B of the groove forming surface 48 are both made of the SUS, which are not subjected to the coating treatment and the cutting treatment. The first facing surface 52A and the second facing surface 52B of the facing surface 52 are both subjected to the titanium coating by TiN. That is, in the three-dimensional shaping device 100 according to the embodiment, the surface free energy of the first forming surface 48A is lower than the surface free energy of the first facing surface 52A, and the surface free energy of the second forming surface 48B is lower than the surface free energy of the second facing surface 52B. With such a configuration, in an entire region in which the groove forming surface 48 and the facing surface 52 face each other, that is, in both of the outer region in which the first forming surface 48A and the first facing surface 52A face each other and the central region in which the second forming surface 48B and the second facing surface 52B face each other, the material is less likely to adhere to the flat screw 40 than to the barrel 50. Therefore, it is possible to improve a conveying force with which the material moves toward the communication hole 56 in the entire region in which the groove forming surface 48 and the facing surface 52 face each other. Therefore, for example, when the nozzle 61 has a small diameter, a plasticized material can be injected from the nozzle 61 under a high pressure.

However, the present disclosure is not limited to a configuration in which the first forming surface 48A, the second forming surface 48B, the first facing surface 52A, and the second facing surface 52B have a surface free energy relationship as described above. For example, the surface free energy of the first forming surface 48A may be lower than the surface free energy of the first facing surface 52A. The surface free energy of the second forming surface 48B may be higher than the surface free energy of the second facing surface 52B. With such a configuration, in the outer region in which the first forming surface 48A and the first facing surface 52A face each other, the material is less likely to adhere to the flat screw 40 than to the barrel 50. Therefore, it is possible to improve the conveying force with which the material moves toward the communication hole 56 in the outer region in which the first forming surface 48A and the first facing surface 52A face each other. The material can be thoroughly plasticized by reducing the conveying force in the central region in which the second forming surface 48B and the second facing surface 52B face each other. Therefore, for example, a plasticized material can be injected with a large injection amount using a large-diameter nozzle 61 as the nozzle 61.

For example, the surface free energy of the first forming surface 48A may be higher than the surface free energy of the first facing surface 52A. The surface free energy of the second forming surface 48B may be lower than the surface free energy of the second facing surface 52B. With such a configuration, in the central region in which the second forming surface 48B and the second facing surface 52B face each other, the material is less likely to adhere to the flat screw 40 than to the barrel 50. Therefore, the material can be thoroughly plasticized by reducing the conveying force in the outer region in which the first forming surface 48A and the first facing surface 52A face each other. It is possible to improve the conveying force with which the material moves toward the communication hole 56 in the central region in which the second forming surface 48B and the second facing surface 52B face each other. Therefore, for example, a material that is difficult to be plasticized can be injected after being thoroughly plasticized in the outer region.

In the three-dimensional shaping device 100 according to the embodiment, a material containing at least one of metal particles and ceramic particles can be used. When a material containing at least one of the metal particles and the ceramic particles is used, the material is likely to adhere to a flat screw 40 side in particular. By adopting the configuration as described above, even in such a case, the material can be prevented from adhering to the flat screw 40 side, and the material can be prevented from being less likely to be supplied to the communication hole 56 on the barrel 50 side. In addition to the material containing at least one of the metal particles and the ceramic particles, it is also possible to use a material containing biodegradable plastics such as polylactic acid and pararesin, cellulose, or a composite thereof.

### Injection Molding Device (Plasticizing Device)

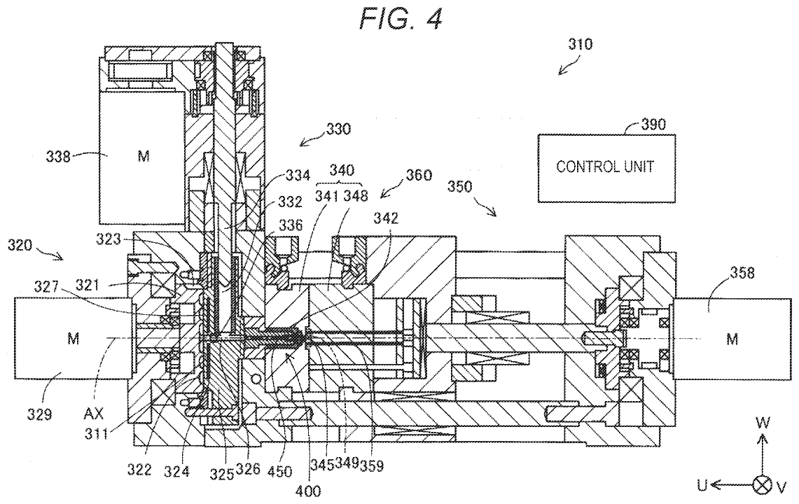

Next, an overall configuration of an injection molding device 310 according to an embodiment of the present disclosure will be described with reference to FIG. 4. The following drawings are all schematic diagrams, and a part of components are omitted or simplified. The injection molding device 310 according to the embodiment includes a flat screw 321 having a groove forming surface similar to that of the flat screw 40 in the three-dimensional shaping device 100, a barrel 325 having a facing surface similar to that of the barrel 50 in the three-dimensional shaping device 100, and a heater 324 as a heating unit. That is, the injection molding device 310 according to the embodiment can be regarded as a plasticizing device that plasticizes a material. The injection molding device 310 can also be regarded as a device that includes a plasticizing device and can perform injection molding using a material plasticized by the plasticizing device.

FIG. 4 schematically shows a cross section of the injection molding device 310 cut along the vertical direction in a cross section including an axis AX of a flow path 450 formed in a hot runner 400. The axis AX corresponds to a rotation axis of the flat screw 321. In FIG. 4, a U axis, a V axis, and a W axis orthogonal to one another are shown. The injection molding device 310 injects a plasticized material into a mold to manufacture a molded article. The injection molding device 310 includes a material generation unit 320, an injection unit 330, a mold 340, a fixing unit 360 that fixes the mold 340, a mold opening and closing unit 350, and a control unit 390.

The material generation unit 320 plasticizes at least a part of a solid material supplied from a hopper, which is not shown, disposed vertically above to generate a molding material having fluidity, and supplies the molding material to an injection unit 330 side. Such a solid material is put into a hopper in various granular forms such as pellets and powders. The material generation unit 320 includes the flat screw 321, the barrel 325, and a drive motor 329.

Similarly to the flat screw 40 in the three-dimensional shaping device 100, the flat screw 321 has a substantially cylindrical external shape in which a length along the axis AX is smaller than a diameter. The flat screw 321 is disposed such that the axis AX of the flow path 450 formed in the hot runner 400 coincides with the axis AX of the flat screw 321. Grooves 322 are formed in a groove forming surface 311 of the flat screw 321. A material inflow port 323 is formed in an outer peripheral surface of the flat screw 321. The grooves 322 are continuous to the material inflow port 323. The material inflow port 323 receives a solid material supplied from the hopper.

The barrel 325 has a substantially disk-shaped external shape, and faces the groove forming surface 311 of the flat screw 321 on a facing surface 327. The heater 324 serving as a heating unit that heats the material is embedded in the barrel 325. However, the heating unit may be provided at a place other than the barrel 325. A through hole 326 penetrating along the axis AX is formed in the barrel 325. The through hole 326 functions as a flow path that guides the molding material to the hot runner 400. The barrel 325 is formed with an injection cylinder 332 penetrating along an axis orthogonal to the axis AX. The injection cylinder 332 constitutes a part of the injection unit 330 and communicates with the through hole 326.

The drive motor 329 is coupled to an opposite-side end surface of the flat screw 321 from a side facing the barrel 325. The drive motor 329 is driven according to a command from the control unit 390, and rotates the flat screw 321 about the axis AX as a rotation axis.

At least a part of the material supplied from the material inflow port 323 is conveyed while being heated by the heater 324 provided in the barrel 325 in the grooves 322 of the flat screw 321 and plasticized by the rotation of the flat screw 321 to increase the fluidity, and is guided to the through hole 326. By the rotation of the flat screw 321, compression and deaeration of the molding material are also implemented.

The injection unit 330 measures the molding material supplied from the material generation unit 320 and injects the measured molding material into a cavity 349 formed in a movable mold 348 of the mold 340. The injection unit 330 includes an injection cylinder 332, an injection plunger 334, a check valve 336, an injection motor 338, and the hot runner 400.

The injection cylinder 332 is formed in a substantially cylindrical shape inside the barrel 325 and communicates with the through hole 326. The injection plunger 334 is slidably disposed in the injection cylinder 332. When the injection plunger 334 slides, the molding material in the through hole 326 is drawn into the injection cylinder 332 and measured. The molding material in the injection cylinder 332 is pressure-fed to a hot runner 400 side and injected into the cavity 349. The check valve 336 is disposed in the through hole 326 on a flat screw 321 side of a communication portion between the injection cylinder 332 and the through hole 326. The check valve 336 allows the molding material to flow from the flat screw 321 side to the hot runner 400 side, and prevents a backflow of the molding material from the hot runner 400 side to the flat screw 321 side. The injection motor 338 is driven according to a command from the control unit 390, and causes the injection plunger 334 to slide in the injection cylinder 332. A sliding speed and a sliding amount of the injection plunger 334 are set in advance according to a type of the molding material, a size of the cavity 349, and the like. The hot runner 400 has a function of guiding the molding material to the cavity 349 in a heated state.

The mold 340 includes a fixed mold 341 and the movable mold 348. A hot runner attachment hole 342 penetrating along the axis AX is formed inside the fixed mold 341. The hot runner 400 is disposed in the hot runner attachment hole 342.

The hot runner attachment hole 342 is formed such that an inner diameter thereof is gradually reduced in order from a material generation unit 320 side. An opposite-side end portion of the hot runner attachment hole 342 from the material generation unit 320 side functions as a gate opening 345 into which the molding material flows. The gate opening 345 is formed as a substantially circular hole.

The movable mold 348 faces the fixed mold 341. The movable mold 348 is brought into contact with the fixed mold 341 during mold closing and mold clamping, including injection and cooling of the molding material, and is separated from the fixed mold 341 during mold opening, including release of a molded article. When the fixed mold 341 and the movable mold 348 come into contact with each other, the cavity 349 communicating with the gate opening 345 is formed between the fixed mold 341 and the movable mold 348. The cavity 349 is designed in advance in a shape of a molded article molded by the injection molding. In the embodiment, the cavity 349 is directly continuous with the gate opening 345, and may be continuous with the gate opening 345 via a runner.

In the embodiment, the mold 340 is formed of an invar material. The invar material has a property of having an extremely small thermal expansion coefficient. A coolant flow path, which is not shown, is formed in the mold 340. When a coolant such as cooling water flows through the coolant flow path, a temperature of the mold 340 is maintained lower than a melting temperature of a resin, and the molding material injected into the cavity 349 is cooled and cured. The coolant flows both during mold clamping and during mold opening. Cooling and curing of the molding material may be implemented using any cooling elements such as a Peltier element, instead of allowing the coolant to flow through the coolant flow path.

The mold opening and closing unit 350 opens and closes the fixed mold 341 and the movable mold 348. The mold opening and closing unit 350 includes a mold opening and closing motor 358 and an extrusion pin 359. The mold opening and closing motor 358 is driven according to a command from the control unit 390 to move the movable mold 348 along the axis AX. Accordingly, the mold closing, the mold clamping, and the mold opening of the mold 340 are implemented. The extrusion pin 359 is disposed at a position communicating with the cavity 349. The extrusion pin 359 releases the molded article by extruding the molded article at the time of mold opening.

The control unit 390 controls an overall operation of the injection molding device 310 to execute the injection molding. The control unit 390 is implemented by a computer including a CPU, a storage device, and an input and output interface. The CPU executes a control program stored in advance in the storage device. The control unit 390 controls a temperature of a heater 130 embedded in the hot runner 400 to adjust the temperature of the hot runner 400. A user of the injection molding device 310 can execute various settings related to injection molding conditions by operating a controller which is an input and output interface of the control unit 390.

The hot runner 400 guides the molding material supplied from the injection unit 330 to the gate opening 345 in the heated state. The hot runner 400 is disposed in the hot runner attachment hole 342 of the fixed mold 341. Instead of the hot runner 400, the injection molding device 310 may include a nozzle in which a flow path for guiding the molding material to the gate opening 345 is formed.

As described above, the injection molding device 310 according to the embodiment includes the flat screw 321 having a groove forming surface similar to that of the flat screw 40 in the three-dimensional shaping device 100, the barrel 325 having a facing surface similar to that of the barrel 50 in the three-dimensional shaping device 100, and the heater 324 as a heating unit. Therefore, the injection molding device 310 has the same characteristics as the characteristics of the plasticizing device described in the three-dimensional shaping device 100. Although the injection molding device 310 according to the embodiment has the overall configuration as described above, the injection molding device 310 is not limited to such a configuration as long as the injection molding device 310 has the characteristics as described above as the plasticizing device.

The present disclosure is not limited to the embodiments described above, and can be implemented in various configurations without departing from the scope of the disclosure. In order to solve a part or all of problems described above, or to achieve a part or all of effects described above, technical characteristics in the embodiments corresponding to the technical characteristics in each embodiment described in the summary of the disclosure can be replaced or combined as appropriate. In addition, when the technical characteristics are not described as essential in the present description, the technical characteristics can be appropriately deleted.

What is claimed is:

1. A plasticizing device for a material, the plasticizing device comprising:
a flat screw that is rotatable about a rotation axis, that has a groove forming surface in which a groove is formed, and that has a length in a direction along the rotation axis shorter than a length in a direction perpendicular to the direction along the rotation axis;
a barrel that has a facing surface facing the groove forming surface and in which a communication hole communicating with the facing surface is formed; and
a heating unit configured to heat the material supplied into the groove, wherein
the groove forming surface has a region having a surface free energy lower than a surface free energy of the facing surface.

2. The plasticizing device according to claim 1, wherein
the groove forming surface has a first forming surface and a second forming surface that is located closer to a central side than is the first forming surface,
the facing surface includes a first facing surface that faces the first forming surface and a second facing surface that faces the second forming surface and that is located closer to the central side than is the first facing surface, and
a surface free energy of the first forming surface is lower than a surface free energy of the first facing surface, and a surface free energy of the second forming surface is lower than a surface free energy of the second facing surface.

3. The plasticizing device according to claim 1, wherein
the groove forming surface has a first forming surface and a second forming surface that is located closer to a central side than is the first forming surface,
the facing surface includes a first facing surface that faces the first forming surface and a second facing surface that faces the second forming surface and that is located closer to the central side than is the first facing surface, and
a surface free energy of the first forming surface is lower than a surface free energy of the first facing surface, and a surface free energy of the second forming surface is higher than a surface free energy of the second facing surface.

4. The plasticizing device according to claim 1, wherein
the groove forming surface has a first forming surface and a second forming surface that is located closer to a central side than is the first forming surface,
the facing surface includes a first facing surface that faces the first forming surface and a second facing surface that faces the second forming surface and that is located closer to the central side than is the first facing surface, and
a surface free energy of the first forming surface is higher than a surface free energy of the first facing surface, and a surface free energy of the second forming surface is lower than a surface free energy of the second facing surface.

5. The plasticizing device according to claim 1, wherein
at least one of the groove forming surface and the facing surface is subjected to a coating treatment or a cutting treatment.

6. The plasticizing device according to claim 5, wherein
the facing surface is subjected to at least one of diamond coating, chromium coating, and titanium coating as the coating treatment.

7. The plasticizing device according to claim 5, wherein
the groove forming surface is subjected to fluorine coating as the coating treatment.

8. The plasticizing device according to claim 1, wherein
the material contains at least one of metal particles and ceramic particles.

9. The plasticizing device according to claim 1, wherein
a difference in surface free energies in the region in which the surface free energy of the groove forming surface is lower than the surface free energy of the facing surface is 4.6 mJ/m² or more.

10. A three-dimensional shaping device comprising:
a nozzle configured to dispense the material plasticized by the plasticizing device according to claim 1; and
a table configured to support the material dispensed from the nozzle.

11. An injection molding device comprising:
a nozzle configured to dispense the material plasticized by the plasticizing device according to claim 1; and
a fixing unit configured to fix a mold configured to receive the material dispensed from the nozzle.
